(19) United States
(12) Patent Application Publication
(10) Pub. No.: US 2016/0107668 A1
(43) Pub. Date: Apr. 21, 2016

(54) FOLDABLE CASE INCLUDING CUP AND MOBILE DEVICE HOLDER

(71) Applicant: Daniel ROBINS, West Chester, PA (US)

(72) Inventor: Daniel ROBINS, West Chester, PA (US)

(21) Appl. No.: 14/885,196

(22) Filed: Oct. 16, 2015

Related U.S. Application Data
(60) Provisional application No. 62/064,639, filed on Oct. 16, 2014.

(51) Int. Cl. B62B 5/00

(52) U.S. Cl. CPC B62B 5/00

(57) ABSTRACT

A folding carrying case includes an internal compartment pivotally retaining a pair of support members therein. One of the support members is pivotally attached to an inner surface of the carrying case and includes a passage for retaining a cup therein. The other support member is pivotally attached the one support member and in an active position is inclined for supporting a mobile device thereon. The carrying case further includes an upstanding flange for receiving and retaining a strap of a purse or other carrying device.

### BACKGROUND OF THE INVENTION

1. Field of Invention

This invention relates to a foldable case including a cup and mobile device holder and more particularly to a foldable case for removable attachment to a shopping cart or similar carrier for holding a cup and mobile device, such as a mobile phone and the like.

2. Description of Related Art

Numerous devices and systems have been disclosed for removably attaching to a shopping cart to support cups and/or other items. For example note the devices disclosed in the following patents:

U.S. Pat. No. 8,474,832 Mersky
U.S. Pat. No. 8,256,651 Reynolds
U.S. Pat. No. 8,245,894 Buehler
U.S. Pat. No. 5,961,018 Abelbeck et al.

A need is believed to exist for a portable holder for a cup and a mobile device that is removably attachable to a shopping cart or similar support (e.g., a baby carriage), that is simple in construction and use, that is easy to carry by the user and is protected against inadvertent damage. It is to such a device that the present invention is directed.

All references cited herein are incorporated herein by reference in their entireties.

### BRIEF SUMMARY OF THE INVENTION

A folding carrying case includes a pair of pivotally attached shells movable between open and closed positions, said shells defining an internal compartment when said shells are in a closed position. A pair of support members are retained in the internal compartment, with one of said support members being pivotally attached to an inner surface of one of the shells of the carrying case and movable from an inactive position and an active position when said shells are in an open position, said one of said support members including a passage for retaining a cup therein when said one of said support members is in an active position. The other support member is pivotally attached at one end to the one support member and is movable between an inactive position and an active position when said shells are in an open position, said other of said support members being inclined for supporting a mobile device thereon when in said active position.

In a preferred embodiment, the folding carrying case includes an upstanding flange for receiving and retaining a strap of a purse or other carrying device.

In a preferred embodiment, the shell that does not pivotally retain the support members thereon (hereinafter “the other shell”) includes an inner surface underlying the passage for retaining the cup and a lower end of the other support member spaced from the one end that is pivotally attached to the one support member, said inner surface being adapted to support a lower surface of a cup retained in said passage and to support said lower end of the other support member. In this manner the other support member functions to both support a mobile device and also to support the first support member in its active position for retaining a cup therein.

In the preferred embodiment, the folding carrying case includes a stop for retaining the shells at approximately a 90 degree orientation to each other when said shells are in an open position. Most preferably the stop is a flange extending downwardly from the shell that does not include said one of said support members pivotally attached thereto, said flange extending downwardly from the shell engaging a lower surface of said one shell when said shells are disposed approximately 90 degrees from each other.

In the preferred embodiment the one shell in which the support members are pivotally retained includes an attachment member on an outer surface for removably attaching the carrying case to a shopping car or other unit; preferably a wheeled unit.

In the most preferred embodiment, each shell includes a main body portion, said main body portions of said shells providing the closed internal compartment when said shells are in a closed position. The one shell pivotally securing the support members therein includes the attachment member on an outer surface of the main body portion thereof for removable attachment to a shopping cart or other unit; preferably a wheeled unit.

In the preferred embodiment the main body portion of each of the shells of the carrying case includes an internal compartment, said internal compartments cooperating to form said closed internal compartment when said shells are in a closed position.

In accordance with the preferred embodiment of this invention the folding carrying case includes a fastener for maintaining the first and second shell in a closed position and being disengageable for permitting the first and second shell to be moved into an open position.

### BRIEF DESCRIPTION OF SEVERAL VIEWS OF THE DRAWINGS

The invention will be described in conjunction with the following drawings in which like reference numerals designate like elements and wherein:

FIG. 1 is an isometric view showing a foldable carrying case of this invention in a closed position;

FIG. 2 is a side elevational view of the foldable carrying case illustrated in FIG. 1;

FIG. 3 is an isometric view showing the foldable carrying case of this invention removably attached to a shopping cart in an open position with a cup holder and mobile device holder in an active position for supporting a cup and mobile device, respectively;

FIGS. 4A-4C showing the foldable carrying case of this invention in an open position, illustrating sequential steps in moving the cup holder and mobile device holder from an inactive position to an active position;

FIG. 4D is an isometric view similar to FIG. 4C and showing the foldable carrying case in use to support a cup, purse and mobile device; and

FIG. 5 is a sectional view along line 5-5 of FIG. 4A showing in solid representation the arrangement of a cup holder and mobile device holder in a retracted, inactive position and, in phantom representation, the cup holder in an active position and the mobile device holder still in an inactive position folded under the cup holder.

### DETAILED DESCRIPTION OF PREFERRED EMBODIMENTS OF THE INVENTION

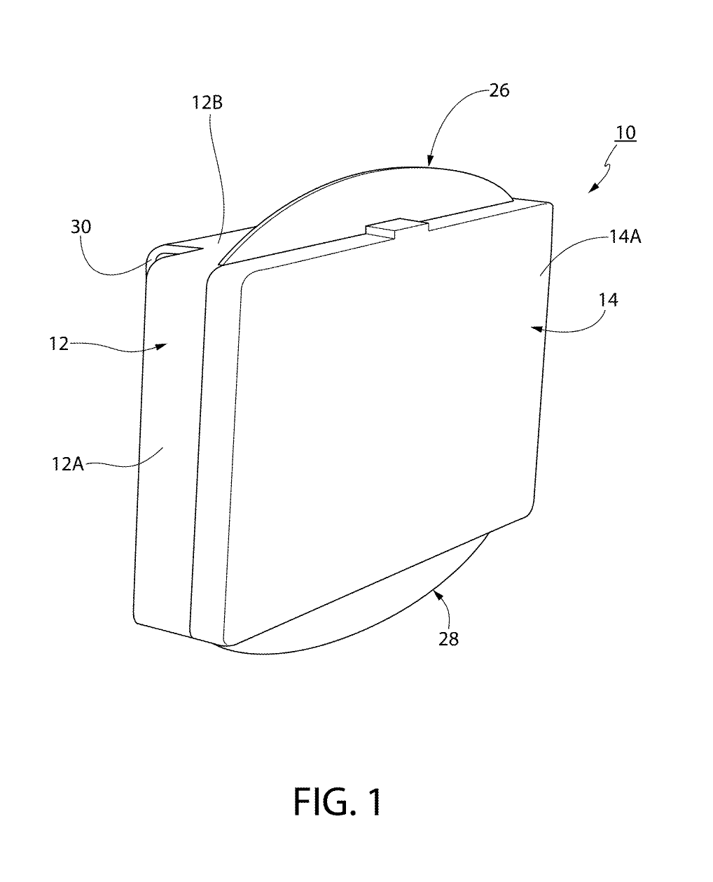

A folding carrying case removably attachable to a shopping cart or other unit, preferably a mobile, wheeled unit, is shown at 10 in FIG. 1. As will be explained hereinafter the folding carrying case 10 includes support members for retaining a cup and a mobile device when a person is using the shopping cart or other unit.

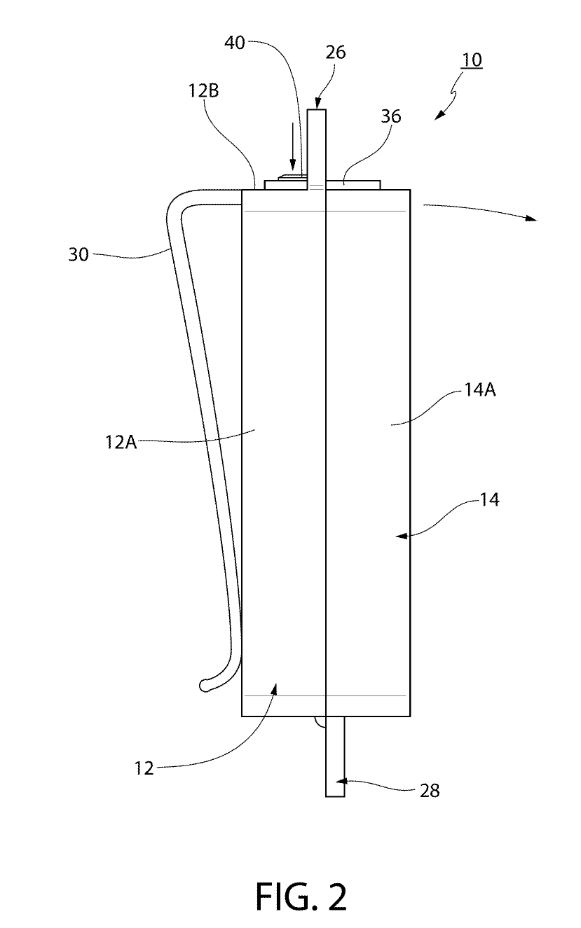

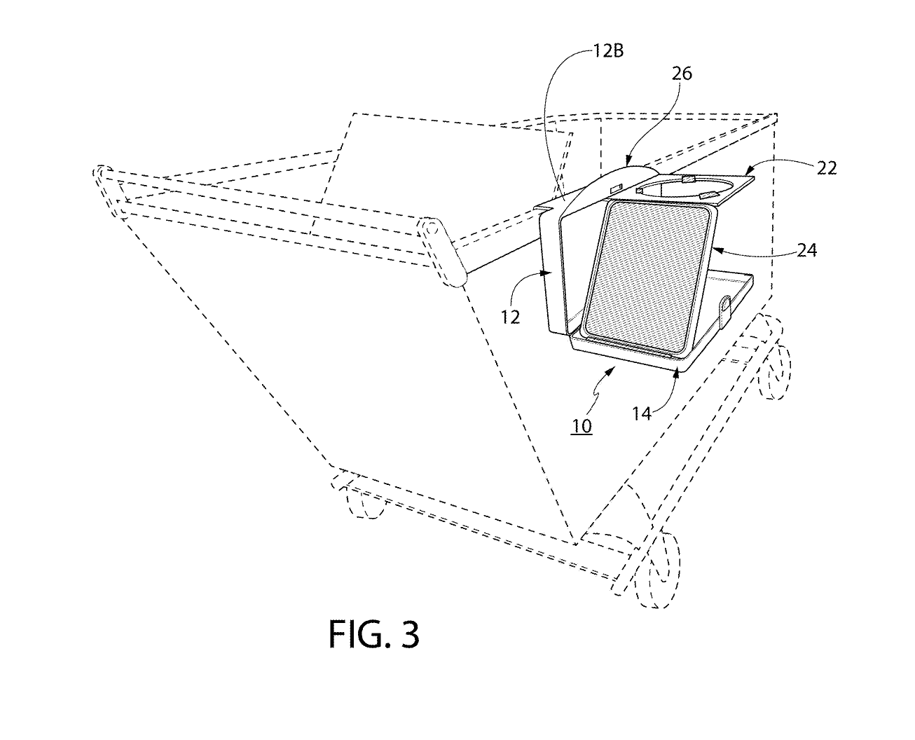

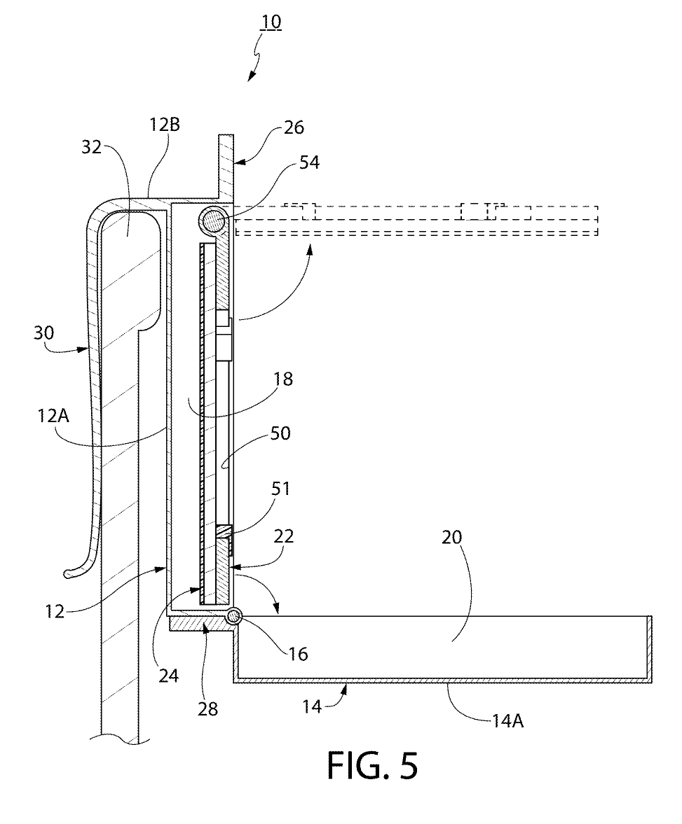

Referring to FIGS. 1 and 5, the carrying case includes first and second shells 12, 14, respective, pivotally connected together adjacent one end through a hinged connection 16 (FIG. 5). These shells 12, 14 are movable between a closed position as shown in FIGS. 1 and 2, and an open position as shown in FIG. 3.

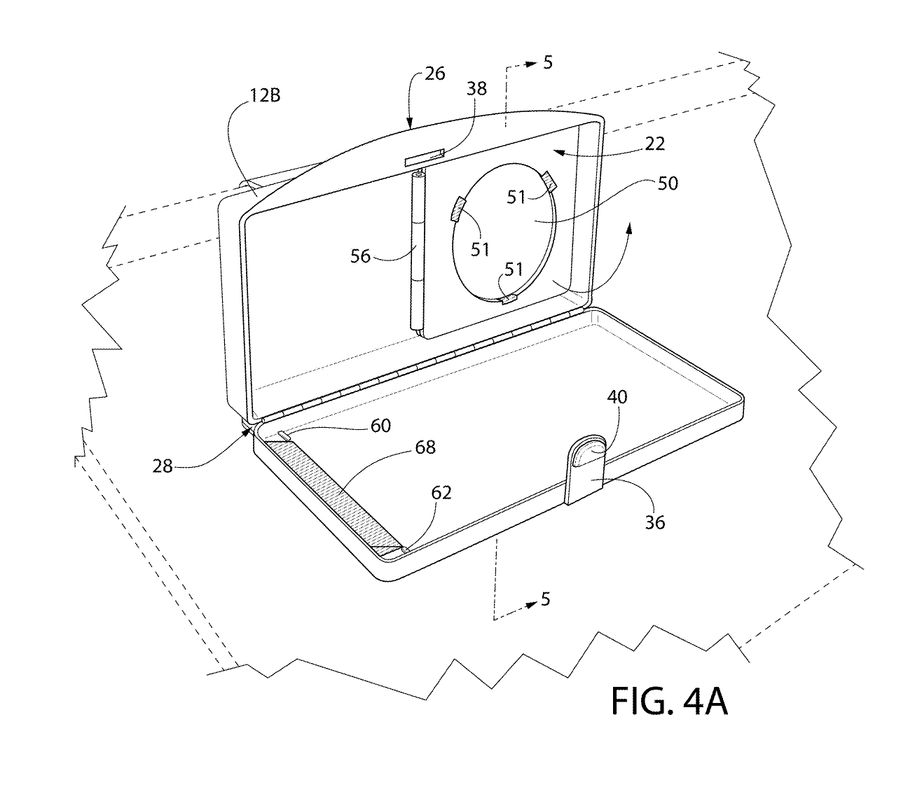

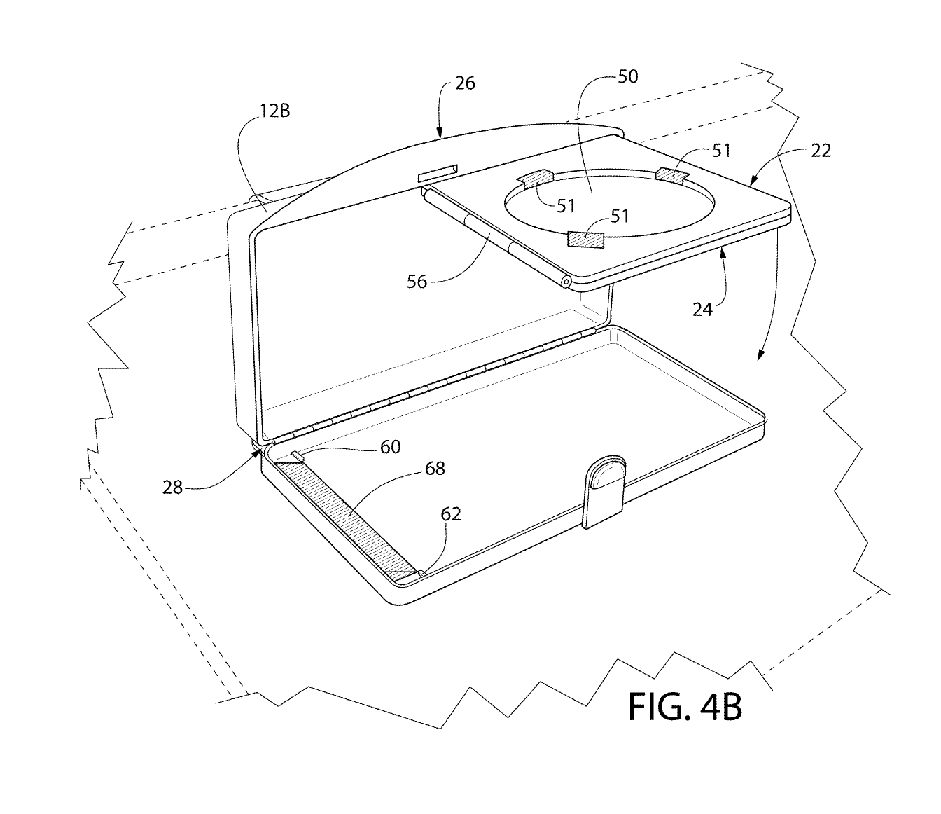

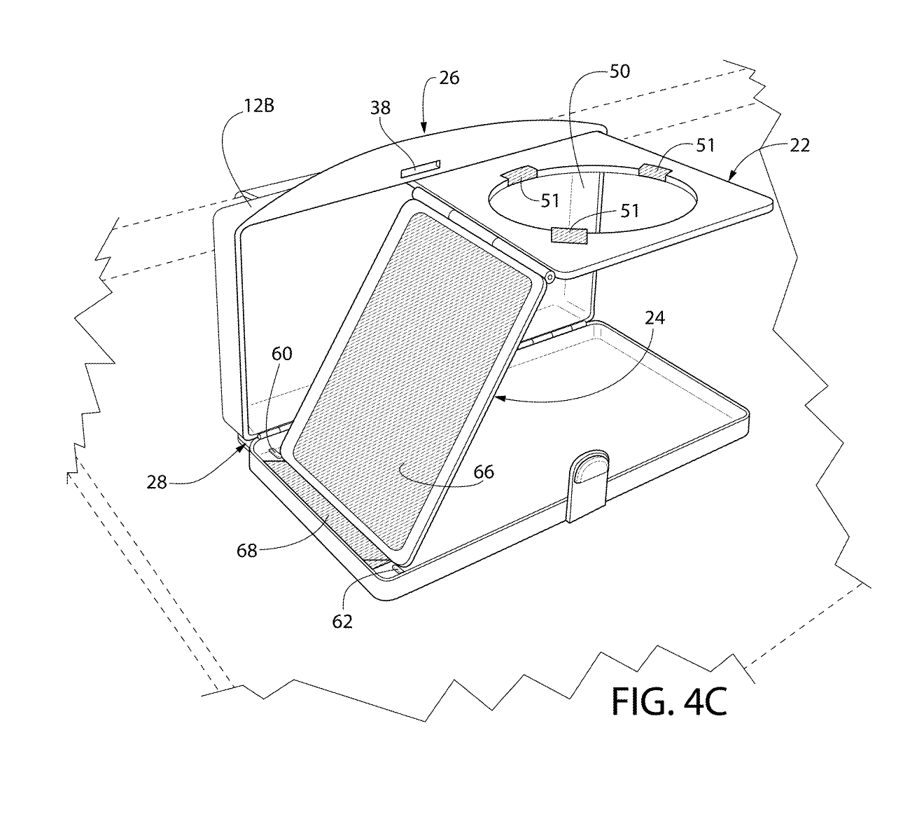

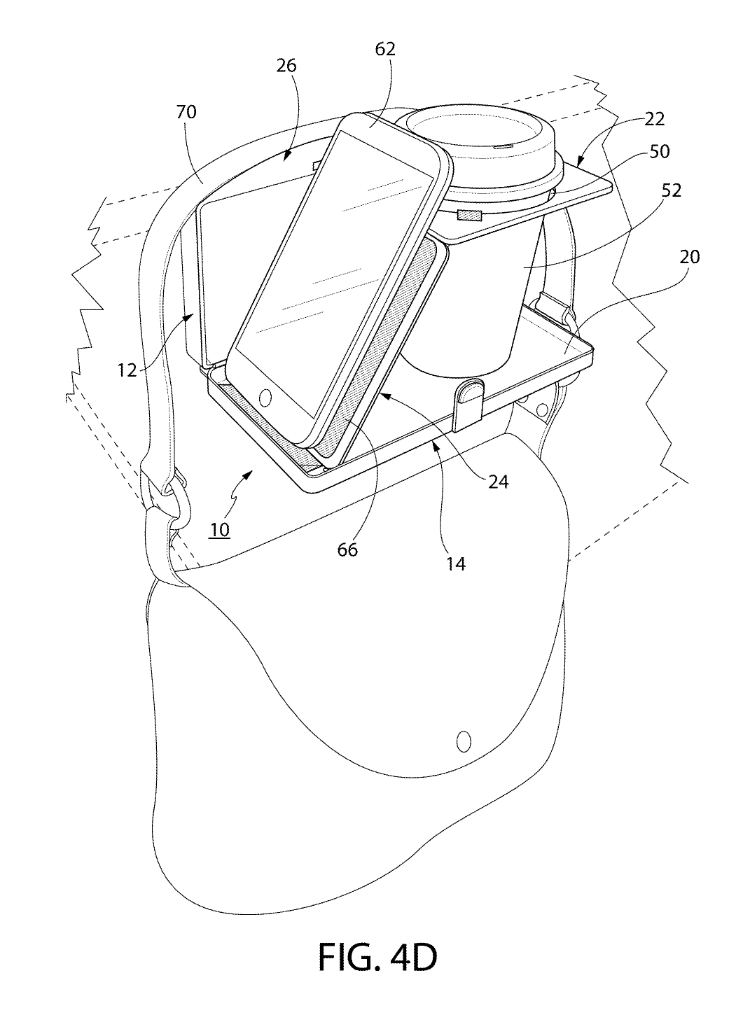

Referring to FIGS. 1, 2 and 5, each of the shells 12, 14, includes a main body portion 12A, 14A. Each of the main body portions 12A, 14A includes an internal compartment section 18, 20, respectively, which cooperate with each other to provide a closed internal compartment when said shells are in a closed position. As will be explained in detail later in this application, a pair of support members 22, 24 (e.g., FIGS. 3 and 5) are retained within the internal compartment and, when in an active position as shown in FIGS. 3, 4C and 4D are capable of supporting a cup, and mobile device, respectively. Also, it should be understood that while in the preferred embodiment each of the main body portions 12A, 14A is provided with an internal compartment section, a closed internal compartment can be provided by internal compartment section 18 cooperating with an internal surface of a shell 14 that does not include an internal compartment section.

Still referring to FIGS. 1 and 2 the shell 12 includes a support flange 26 extending upwardly from the main body portion 12A of the shell 12, and the shell 14 includes a stop flange 28 extending downwardly from the shell 14. The function and operation of the flanges 26, 28 will be described in detail later in this application.

As can be seen best in FIGS. 2 and 5, the first shell 12 includes attachment member in the form of a spring clip 30 on an outer surface of the main body portion 12A. This spring clip 30 is adapted to be snapped over the railing 32 of a shopping cart or other mobile device, such as a baby stroller or other wheeled vehicle.

As can be seen best in FIGS. 2 and 4A, the second shell 14 includes a fastener 34 in the form of a flexible strap 36 adapted to be inserted through a passage 38 in support flange 26. The distal end of the flexible strap 36 includes a raised stop 40 that is compressed to permit the strap to be inserted into the passage 38. The raised stop will then snap into engagement with the rear surface of the flange 26 to maintain the folding case 10 in a closed position.

When it is desired to open the case and position the pair of support members 22, 24 in an active position for retaining a cup and supporting a mobile device, the raised stop 40 is compressed to permit the flexible strap 26 of the fastener 14 to be pulled out of the passage 38.

As can be seen best in FIG. 5, but also viewable in other figures, the stop flange 28 limits the pivotal movement of the shells 12 and 14 relative to each other by engaging the lower surface 42 of the main body portion 12A of the shell 12 when the shell 14 is oriented approximately 90 degrees to the shell 12. This provides a simple and reliable arrangement for maintaining the shells 12 and 14 in a desired open position to permit use of the support member 22, 24 for supporting a cup and mobile device, respectively.

Referring to FIGS. 4A and 5, the folded, inactive position of the support members 22, 24 is shown. These support members are folded into the inactive position for storage within the interior compartment of the carrying case 10, when said carrying case is in a closed position. In fact, the folded support members 22, 24 are maintained completely within the internal compartment section 18 of the main body portion 12A of the shell 12. Although it is preferred to include an internal compartment 20 in the main body portion 14A of the shell 14 to provide an enhanced depth for supporting a cup, within the broadest aspects of this invention the shell 14 could be a planar member free of an internal compartment.

Still referring to FIGS. 4A-4D, the support member 22 includes a passage 50 extending through it to support a cup 52 therein when said support member is in an active position, e.g., FIG. 4D. In a preferred embodiment the periphery of the passage includes spaced-apart gripping tabs 51, preferably made of a rubber-based material, to aid in gripping the outer periphery of a cup 52 supported within said opening, Of course, whether the tabs 51 are employed to providing a gripping function depends upon the diameter of the cup retained within the passage 50. As can be seen in FIG. 5, the support member 22 is connected to an inner peripheral wall defining the internal compartment 18 through a pivot axle 54.

Referring to FIGS. 4A-4C, the support member 24 is pivotally connected to an end of the support member 22 through pivot connection 56, and is movable between an inactive position underlying the support member 22, to an active position after the support member 22 is moved into an active position. Specifically, the active positions of the support members 22 and 24 can be seen best in FIGS. 3, 4C and 4D.

Referring to FIGS. 4A-4C, a pair of lower projections or stops 60, 62 is provided at corners of the internal compartment 20 of the shell 14 to provide a limiting stop for the support member 24. That is, the stops 60, 62 engage the lower end of the support member 24 when the support member is in the desired inclined position for use in supporting a mobile device, such as a mobile phone 64 (see FIG. 4C).

Referring to FIGS. 4A-4D, a rubber or other cushioning support 68 is attached to the inner or base wall of the compartment 20 between the stops 60, 62 to provide a cushioning support for the mobile device, e.g., mobile phone 64 when said device is supported by the inclined surface of the support member 24. In the preferred embodiment the support surface 66 of the support member 24 is a rubber surface; preferably embossed to provide frictional engagement with the back of the mobile device or a cover or case for the mobile device.

Referring to FIG. 4D, a preferred use of this invention is shown. Specifically, the folding carrying case 10 is in an open position, with the shell 14 being disposed substantially 90 degrees from the shell 12. The cup 52 is retained within passage 50 of the support member 22 and the bottom of the cup is supported on the inner or base wall of the compartment 20 of the shell 14. The mobile device, e.g., mobile phone 62 is supported on the rubber support surface 66 of the support member 24, with the lower surface of the mobile device engaging and supported by the cushioning support 68. As illustrated, the strap 70 of a purse 72, or other carrying device can be placed over the upper support flange 26; preferably also in contact with upper peripheral wall 12B of the main body section 12A of the shell 12.

Thus, the foldable carrying case 10 including the internal support members 22 and 24 therein has multiple applications, including the supporting of a cup (e.g., beverage cup 52), mobile device (e.g. mobile phone 64) and the strap (e.g., 70) of a purse or other carrying device provided with a strap.

While the invention has been described in detail and with reference to specific examples thereof, it will be apparent to one skilled in the art that various changes and modifications can be made therein without departing from the spirit and scope thereof. It also should be noticed that references to orientation, e.g., upper, lower, downward refer to the orientations that exist when the carrying case is attached to a horizontal rail of a shopping car or other device.

What is claimed is:

1. A folding carrying case removably attachable to a shopping cart or other unit and including a cup holder and a support for a mobile device, said carrying case including:
A. First and second shells pivotally connected together adjacent one end and movable between an open position and a closed position, each shell including a main body portion, said main body portions of said shells providing a closed internal compartment when said shells are in a closed position;
Said first shell including an attachment member on an outer surface of the main body portion thereof, said attachment member being removably attachable to said shopping cart or other unit;
Said second shell including an inner surface constituting a supporting surface adapted to support a cup and mobile device when said first and second shells are in an open position;
A stop member forming part of the carrying case for maintaining the second shell substantially perpendicular to said first shell when said first and second shells are in an open position;
B. A pair of support members pivotally attached together and one of said pair of support members being pivotally attached to said first shell; said one of said pair of support members including a passage for receiving a cup therethrough and being pivotally movable from a folded, inactive position adjacent an inner surface of the main body portion of said first shell, to an active position substantially normal to said inner surface, said other of said pair of support members being pivotally movable from a folded, inactive position generally parallel to said one of said pair of support surfaces, to an active position disposed at an inclined angle to said one of said pair of support members and including a lower, distal end engaging an internal surface of the second shell when said first and second shells are in an open position to aide in maintain the one of said pair of support members in said active position while providing a support for a mobile device or other device; said first and second support members when in their inactive positions permitting the first and second shells to be maintained in a closed position with said first and second support members disposed in said closed internal compartment.

2. The folding carrying case of claim 1, wherein the main body portion of each of said shells includes an internal compartment, said internal compartments cooperating to form said closed internal compartment when said shells are in a closed position.

3. The folding carrying case of claim 1, wherein said first shell includes a flange extending upwardly from the main body portion thereof when said first shell is attached to a shopping cart or similar unit, said flange providing a member for supporting a strap of a purse, handbag or other article.

4. The folding carrying case of claim 1, wherein said second shell includes a flange extending downwardly therefrom, said flange constituting said stop member for engaging a lower surface of said first shell when said first and second shells are in an open position to thereby maintain the second shell substantially perpendicular to said first shell.

5. The folding carrying case of claim 1, wherein said first shell includes a flange extending upwardly from the main body portion thereof when said first shell is attached to a shopping cart or similar unit, said flange providing a member for supporting a strap of a purse, handbag or other item; said second shell including a flange extending downwardly from the main body portion of said second shell, said downwardly extending flange constituting said stop member for engaging a lower surface of said first shell when said first and second shells are in an open position to thereby maintain the second shell substantially perpendicular to said first shell.

6. The folding carrying case of claim 1, including a fastener for maintaining said first and second shells in a closed position and being disengageable for permitting said first and second shells to be moved into an open position.

7. A folding carrying case comprising a pair of pivotally attached shells movable between open and closed positions, said shells defining an internal compartment when said shells are in a closed position, a pair of support members disposed in said internal compartment, one of said support members being pivotally attached to an inner surface of one of the shells of the carrying case and movable from an inactive position and an active position when said shells are in an open position, said one of said support members including a passage for retaining a cup therein when said one of said support members is in an active position, the other support member being pivotally attached at one end to the one support member and being movable between an inactive position and an active position when said shells are in an open position, said other of said support members being inclined for supporting a mobile device thereon when in said active position.

8. The folding carrying case of claim, 7 further includes an upstanding flange for receiving and retaining a strap of a purse or other carrying device.

9. The folding carrying case of claim 7, wherein the other of said pair of shells including an inner surface underlying the passage for retaining the cup and a lower end of the other support member spaced from said one end, said inner surface being adapted to support a lower surface of a cup retained in said passage and to support said lower end of the other support member.

10. The folding carrying case of claim 7, further including a stop for retaining the shells at approximately a 90 degree orientation to each other when said shells are in an open position.

11. The folding carrying case of claim 10, wherein said stop is a flange extending downwardly from the shell that does not include said one of said support members pivotally attached thereto, said flange extending downwardly from the shell engaging a lower surface of said one shell when said shells are disposed approximately 90 degrees from each other.
